(19) United States
(12) Patent Application Publication
(10) Pub. No.: US 2009/0050557 A1
(43) Pub. Date: Feb. 26, 2009

(54) HIGH-BOND STRENGTH SILICON AND A METHOD FOR THE PRODUCTION AND USE THEREOF

(75) Inventors: Anne Bouchara, Paris (FR); Robert Eberhardt, Ellwangen (DE); Eric Perin, Villefranche Sur Saone (FR)

Correspondence Address: BUCHANAN, INGERSOLL & ROONEY PC, POST OFFICE BOX 1404, ALEXANDRIA, VA, 22313-1404, US

(73) Assignee: RHODIA RECHERCHES ET TECHNOLOGIES, AUBERVILLIERS (FR)

(21) Appl. No.: 12/088,834

(22) PCT Filed: Sep. 12, 2006
(86) PCT No.: PCT/FR06/02088

§ 371 Date: Nov. 7, 2008

(30) Foreign Application Priority Data
Sep. 30, 2005 (FR) 0510006

(51) Int. Cl. B01D 24/00; B32B 5/16; A24D 3/16; C01B 33/12; B32B 5/18

(52) U.S. Cl. 210/500.1; 428/402; 428/404; 428/316.6; 55/522; 131/331; 423/335

(57) ABSTRACT

High-bond strength silicons having a median particle size of at least 100 μm, a porous volume (Vd1), formed by pores whose diameter ranges from 3.6 to 1,000 nm, of at least 0.3 cm³/g, a mean pore diameter for the pores, whose diameter ranges from 3.6 to 1,000 nm, greater than 11 nm and a cohesive index (IC) less than 0.25 are provided. Also provided are methods for producing such silicons by silicon wet granulation, heat treating and possible sieving. The silicons can be used in the form of a liquid carrier, a catalyst carrier or additive and for liquid or gaseous filtering.

The present invention relates to a highly cohesive silica and to a process for the preparation of such silica.

It also relates to its uses, in particular as liquid carrier, catalyst support or additive or for liquid or gas filtration.

It is known to condition liquids on solid supports, in particular on a silica support.

It is also known to use a compound, such as activated carbon, for its adsorption properties, in particular for liquid or gas filtration, especially in cigarette filters.

One of the aims of the invention is to provide a novel product, exhibiting high cohesion and preferably low, indeed even zero, dust generation, which can be satisfactorily used as liquid carrier or for gas or liquid filtration, in particular in cigarette filters, especially as active filter, for example, by supplementing or replacing activated carbon in its retention role.

A subject matter of the invention is thus a silica, characterized in that it exhibits:
a median particle size of at least 100 μm and preferably of at most 2000 μm,
a pore volume (Vd1), composed of the pores with a diameter of between 3.6 and 1000 nm, of at least 0.3 cm³/g,
a mean pore diameter, for the pores of the diameter of between 3.6 and 1000 nm, of greater than 11 nm, and
a cohesive index (CI) of less than 0.25.

The median particle size (D50ᵢₙᵢₜᵢₐₗ) is measured by laser diffraction, for example according to the standard NF X 11-666, using a particle sizer of Malvern Mastersizer 2000 type (from Malvern Instruments), in the absence of ultrasound and of dispersant, the measurement liquid being degassed demineralized water (2 g of sample being dispersed in 50 ml of water with magnetic stirring) and the measurement time being 10 seconds. The value retained is the mean of three measurements carried out consecutively on the same sample.

The cohesive index (CI) depends on this median particle size, determined without ultrasound, and on the median particle size (D50_{2 min}) determined, using the same particle sizer of the Malvern Mastersizer 2000 type (from Malvern Instruments), after treatment with ultrasound as follows: 2 g of sample are dispersed in 50 ml of water (demineralized and degassed) with mechanical stirring and are then treated with ultrasound (without mechanical stirring) for 2 minutes using a 450 watt probe operating at 70% of its power, that is to say at 315 watts. The measurement time is 10 seconds. The value retained is the mean of three measurements carried out consecutively on the same sample.

The cohesive index (CI) is defined in the following way:

CI=PD50/D50ᵢₙᵢₜᵢₐₗ, PD50 being the absolute value of the slope of the straight line obtained by representing the median particle size as a function of the time, that is to say PD50 being equal to |(D50_{2 min}−D50_{initial)/(}2−0)|.

For highly cohesive products, the value measured for the median particle size after treatment with ultrasound (D50_{2 min}) may be greater than that of the initial median particle size (D50ᵢₙᵢₜᵢₐₗ), due to the uncertainty in the measurement; the cohesive index (CI) is then set at 0.

The lower the cohesive index (CI), the higher the cohesion of the sample and thus the lower the tendency of the sample to break and/or split when it is handled and used.

The pore volumes given are measured by mercury porosimetry; for these measurements, each sample can be prepared as follows: each sample is dried beforehand in an oven at 200° C. for 2 hours and is then placed in a test vessel in the 5 minutes following its departure from the oven and degassed under vacuum, for example using a rotary vane pump; the pore diameters are calculated by the Washburn relationship with a contact angle theta equal to 140° and a surface tension gamma equal to 484 dynes/cm (Micromeritics 9300 porosimeter, for example). In the present description, only the pores exhibiting a diameter of between 3.6 and 1000 nm are taken into account.

The silica according to the invention exhibits a median particle size of at least 100 μm. Preferably, it is at most 2000 μm. It can be between 100 and 1000 μm.

It generally has a median particle size of greater than 250 μm (in particular varying from 250 (nonincluded) to 2000 μm, indeed even to 1000 μm), preferably of greater than 300 μm (in particular varying from 300 (nonincluded) to 2000 μm, indeed even to 1000 μm).

Its median particle size is in particular greater than 300 μm and lower than 590 μm, for example between 330 and 580 μm. It can in particular be between 340 and 470 μm, indeed even between 390 and 450 μm or between 400 and 440 μm.

The silica according to the invention has an intraparticle pore volume (Vd1), composed of the pores with a diameter of between 3.6 and 1000 nm, of at least 0.3 cm³/g and usually of at most 3.0 cm³/g.

Its pore volume (Vd1) is generally at least 0.5 cm³/g, preferably at least 0.8 cm³/g. It can in particular be between 0.8 and 3.0 cm³/g, in particular between 0.8 and 2.0 cm³/g, for example between 0.85 and 1.6 cm³/g. More preferably still, its pore volume (Vd1) is at least 0.9 cm³/g, in particular at least 1.1 cm³/g, especially at least 1.15 cm³/g, for example at least 1.2 cm³/g. It can thus be between 1.2 and 3.0 cm³/g, indeed even between 1.2 and 2.0 cm³/g or between 1.2 and 1.6 cm³/g.

The silica in accordance with the invention exhibits a mean pore diameter, for the pores with a diameter of between 3.6 and 1000 nm, of greater than 11 nm (for example of between 11 (nonincluded) and 100 nm or between 11 (nonincluded) and 50 nm), preferably of at least 12 nm, for example between 12 and 100 nm; it can be between 12 and 50 nm, in particular between 12 and 25 nm, especially between 12 and 20 nm, for example between 12.5 and 17 nm; it can also be between 13 and 25 nm, for example between 14 and 25 nm, indeed between 14.5 and 18 nm.

The silica according to the invention exhibits a high cohesive force.

It has a cohesive index (CI) of less than 0.25, preferably of less than 0.20, in particular of less than 0.15. It cohesive index (CI) can in particular be less than 0.12, for example less than 0.10. It can be at most 0.09, indeed even 0.07.

The silica according to the invention usually has a BET specific surface of at least 50 m²/g.

Generally, its BET specific surface is less than 1200 m²/g and in particular at most 1000 m²/g, especially at most 900 m²/g, for example at most 700 m²/g.

The BET specific surface is determined according to the Brunauer-Emmett-Teller method described in “The Journal of the American Chemical Society”, Vol. 60, page 309, February 1938, which corresponds to the standard NF T 45007 (November 1987).

The BET specific surface of the silica according to the invention can be at least 100 m²/g, generally at least 160 m²/g, preferably at least 200 m²/g (for example greater than 300 m²/g); it can be between 250 and 900 m²/g, in particular between 280 and 800 m²/g, for example between 310 and 700 m²/g; it can also be between 350 and 900 m²/g, in particular between 350 and 700 m²/g, especially between 360 and 620 m²/g, for example between 360 and 500 m²/g.

According to a specific embodiment, the silica in accordance with the invention exhibits, on the one hand, a median particle size of greater than 300 μm (and, for example, of at most 2000 μm), in particular of between 320 and 600 μm, for example between 330 and 580 μm, and, on the other hand, a BET specific surface of greater than 300 m²/g (and, for example, of at most 1200 m²/g), in particular of between 350 and 900 m²/g, especially between 350 and 700 m²/g, for example between 360 and 620 m²/g, indeed even between 360 and 500 m²/g. In this specific embodiment, the silica in accordance with the invention preferably has a cohesive index (CI) of less than 0.12, for example of less than 0.10.

The silica according to the invention can have a residual moisture content (residual water content measured according to the standard ISO 787/2, after heat treatment at 105° C. for 2 hours) of at most 10% by weight, in particular of between 1 and 10% by weight, for example between 3 and 9% by weight.

The silica according to the present invention is preferably provided in the form of granules.

It advantageously consists of a synthetic amorphous silica.

The silica according to the invention can be a pyrogenic silica, a colloidal silica, a silica gel, a precipitated silica or one of their mixtures.

Very preferably, the silica according to the present invention is a precipitated silica.

At least one binder, in particular at least one inorganic binder, can be present in the silica in accordance with the invention.

It can be chosen from alkaline earth metal (in particular calcium), magnesium or beryllium salts, for example chlorides. It can also be chosen from alkali metal (in particular sodium or potassium); alkaline earth metal, magnesium and beryllium aluminates or, preferably, silicates. It can also be chosen from alkaline earth metal (in particular calcium), magnesium or beryllium carbonates, or alkaline earth metal (in particular calcium) hydroxides optionally treated with CO₂. It can in addition be chosen from inorganic particles of nanometric size, in particular oxides, especially of silicon, of titanium or of cerium.

Preferably, said inorganic binder is an alkaline earth metal salt, for example a chloride, the alkaline earth metal being in particular calcium, an alkali metal silicate, the alkali metal being in particular sodium, or an alkaline earth metal carbonate, the alkaline earth metal being in particular calcium. When the inorganic binder is a sodium silicate, the latter can exhibit an SiO₂/Na₂O ratio by weight of between 1.0 and 4.0, in particular between 2.5 and 4.0, for example between 3.0 and 3.8.

The silica according to the invention can comprise between 0.05 and 10.0% by weight, preferably between 0.05 and 4.0% by weight, in particular between 0.05 and 2.8% by weight, for example between 0.1 and 2.5% by weight, of inorganic binder.

It should be noted that the surface of the particles of the silica according to the invention can be functionalized, in particular by grafting or adsorption of organic molecules comprising, for example, at least one amino, phenyl, alkyl, cyano, nitrile, alkoxy, hydroxyl, amide, thio and/or halogen functional group.

The silica in accordance with the invention advantageously exhibits a cohesive index (CI) substantially comparable to that of activated carbon, in particular coconut activated carbon, which is a product widely used for its adsorption properties. Likewise, advantageously, its cohesive index (CI) is much lower than that of known precipitated silicas.

The silica according to the invention preferably generates little, indeed even no, dust, in particular when it is handled.

The silica according to the invention is preferably obtained by wet granulation, followed by heat treatment, of a silica, for example of a pyrogenic silica, of a colloidal silica, of a silica gel, of a precipitated silica or of one of their mixtures; the starting silica preferably consists of a precipitated silica.

Another subject matter of the invention is thus a process for the preparation of the silica in accordance with the invention by wet granulation of silica, preferably of precipitated silica, generally in the presence of a (water-)soluble inorganic binder, followed by heat treatment and optionally sieving.

The silica, preferably a precipitated silica, employed in the granulation stage (that is to say, the starting silica used in the preparation process) generally exhibits a median particle size of at least 0.5 μm, in particular of between 0.5 and 50 μm, especially between 1 and 20 μm, for example between 2 and 10 μm.

It usually has a BET specific surface of at least 50 m²/g, in particular of greater than 160 m²/g, for example greater than 300 m²/g, while generally being less than 1200 m²/g, in particular less than 1000 m²/g.

The silica, preferably a precipitated silica, employed in the granulation stage can exhibit an oil (DOP) uptake of at least 80 ml/100 g, preferably of at least 200 ml/100 g, in particular of at least 270 ml/100 g, especially of at least 295 ml/100 g, indeed even of at least 300 ml/100 g. It can be at least 350 ml/100 g, for example at least 380 ml/100 g. It is generally less than 500 ml/100 g, indeed even less than 420 ml/100 g.

The oil (DOP) uptake can be measured according to the standard NF T 30-022 (March 1953) by employing dioctyl phthalate.

The precipitated silica preferably used as starting silica can be prepared by a precipitation reaction of a silicate, such as an alkali metal silicate (for example sodium silicate), with an acidifying agent (for example sulfuric acid), with production of a precipitated silica suspension, followed, usually, by separation, in particular by filtration (with production of a filtration cake), of the precipitated silica obtained and, finally, by drying (generally by atomization). The preparation of the precipitated silica can be carried out according to any form: in particular, addition of acidifying agent to a silicate vessel heel, simultaneous total or partial addition of acidifying agent and of silicate to a vessel heel formed of water and of silicate.

The starting silica is preferably employed, in particular in the case of a precipitated silica, in the dry (or powder) form; the size of the particles can optionally be adjusted beforehand, for example by passing through a mill or through an air jet micronizer. A suspension in water of a silica, in particular of the same silica, can optionally be used in addition to the silica in the dry (or powder) form; for example, in the case of a precipitated silica, it is optionally possible to additionally employ the silica suspension or the filtration cake resulting from the preparation of the silica before drying.

In the process according to the invention, the granulation stage is generally carried out in a granulation device by processing (in particular mixing) a silica, in particular as described above, preferably a precipitated silica, and a water-comprising binder.

The processing of the binder can consist of the addition of water (the water then playing only the role of binder), or of the addition of water and of at least one soluble inorganic binder (soluble optionally in aqueous solution), or, preferably, of the addition of an aqueous solution of a soluble inorganic binder.

The inorganic binder can in particular be chosen from alkaline earth metal (in particular calcium), magnesium or beryllium salts, for example chlorides. It can also be chosen from alkali metal (in particular sodium or potassium), alkaline earth metal, magnesium and beryllium aluminates or, preferably, silicates. It can also be chosen from alkaline earth metal (in particular calcium), magnesium or beryllium carbonates, or alkaline earth metal (in particular calcium) hydroxides optionally treated with CO₂. It can in addition be chosen from inorganic particles of nanometric size, in particular oxides, especially of silicon, of titanium or of cerium.

Preferably, said inorganic binder is an alkaline earth metal salt, for example a chloride, the alkaline earth metal being in particular calcium, an alkali metal silicate, the alkali metal being in particular sodium, or an alkaline earth metal carbonate, the alkaline earth metal being in particular calcium. When the inorganic binder is a sodium silicate, the latter can exhibit an SiO₂/Na₂O ratio by weight of between 1.0 and 4.0, in particular between 2.5 and 4.0, for example between 3.0 and 3.8.

Generally, use is made of an amount of inorganic binder such that the silica obtained on conclusion of the process comprises between 0.05 and 10.0% by weight, preferably between 0.05 and 4.0% by weight, in particular between 0.05 and 2.8% by weight, for example between 0.1 and 2.5% by weight, of inorganic binder.

Thus, when the inorganic binder is used in the form of an aqueous solution, the latter can, for example, exhibit a content of inorganic binder of between 0.02 and 5% by weight, preferably between 0.02 and 2.0% by weight, in particular between 0.02 and 1.5% by weight, especially between 0.05 and 1.3% by weight.

An acidic or basic agent can optionally be added to the granulation device in order to adjust the pH.

Advantageously, the total liquid volume (comprising in particular binder) employed, per 100 g of silica used, in the granulation stage represents from 40 to 70%, preferably 45 to 65%, in particular 50 to 60%, for example 50 to 55% or 55 to 60%, of the value of the oil (DOP) uptake of the silica used.

The granulation stage can take place continuously or batchwise.

The granulation stage can be carried out in a mechanical rotary granulator.

Use may be made of a rotary granulator equipped with plowshares, in particular a Lödige granulator.

The granulation stage is preferably carried out in a high-shear granulator.

Use is preferably made of a rotary granulator equipped with blades or pins, in particular a Zanchetta granulator (rapid mixer), which generally operates under batchwise conditions.

Generally, 25 to 75% of the volume of the pan of the granulator, in particular in the case of a Rotolab Zanchetta granulator, are filled initially with the starting precipitated silica.

The speed of the rotor of the granulator, in particular in the case of a Rotolab Zanchetta granulator, is usually between 200 and 1000 revolutions/min, for example between 400 and 600 revolutions/min.

The granulation operation is generally carried out with stirring.

The granulation operation can be carried out at ambient temperature (temperature of the site of the plant).

In a rotary granulating device equipped with blades or pins, in particular of Rotolab Zanchetta type, the residence time of the starting materials in the granulation device, including the addition time for the water-comprising binder and the granulation time, can be, in particular for batchwise operation, between 15 and 60 minutes, for example between 20 and 45 minutes, indeed even between 20 and 30 minutes, it being possible for the granulation time to vary from 1 to 40 minutes, in particular from 2 to 30 minutes, for example from 3 to 15 minutes.

In a rotary granulating device equipped with plowshares, in particular of the Lödige type with a volume of 5 liters, the residence time of the starting materials in the granulation device, including the addition time for the water-comprising binder and the granulation time, can be, in particular for batchwise operation, between 25 and 65 minutes, in particular between 25 and 45 minutes, it being possible for the granulation time in particular to vary from 3 to 40 minutes, for example from 4 to 35 minutes.

The addition time for the water-comprising binder can in particular be between 10 and 35 minutes, especially between 10 and 25 minutes.

The residence time of the starting materials and the granulation time can depend in particular on the granulator employed, on its volume, on the peripheral speed developed at the end of the rotor and on the amount of liquid used.

In the process according to the invention, the heat treatment preferably comprises a drying stage, preferably at a temperature of between 40 and 120° C., in particular between 50 and 100° C.

The drying stage can be carried out using any known drying means (oven or fluidized bed, in particular).

It can optionally be incorporated in the granulation device.

The drying stage takes place, for example, for a time sufficient to achieve a possible desired value for relative moisture content which can preferably be at most 10% by weight, in particular between 1 and 10% by weight, in particular between 3 and 9% by weight.

The duration of the drying stage can in general be between 2 and 60 hours, in particular between 6 and 50 hours.

In the process according to the invention, the heat treatment can comprise a calcination stage, preferably at a temperature of at least 200° C., in particular of between 250 and 500° C., especially between 300 and 450° C., the calcination stage being subsequent to the drying stage when the heat treatment comprises such a drying stage.

Preferably, the process according to the invention comprises such a calcination stage, this being more preferably still after a drying stage.

The calcination stage is generally carried out for 1 to 24 hours, for example between 1 and 3 hours, this being done usually under air and in particular at atmospheric pressure.

The process according to the invention can comprise, after the heat treatment, a sieving (separation) stage in order to remove the possible products which do not have the desired size, in particular according to the applications targeted.

It is possible, on conclusion of the heat treatment or of the possible sieving, to graft or adsorb organic molecules, for example comprising at least one amino, phenyl, alkyl, cyano, nitrile, alkoxy, hydroxyl, amide, thio and/or halogen functional group, to or at the surface of the silica obtained, in particular in the form of granules.

The process according to the invention can optionally comprise a stage of shaping the silica obtained.

The silica according to the invention or obtained by the process according to the invention can be employed in particular as liquid carrier.

Mention may in particular be made, as liquid, of organic liquids, such as organic acids, surface-active agents, organic additives for rubber/polymers, or pesticides.

Use may be made, as liquid, of preservatives (phosphoric acid or propionic acid, in particular), flavorings, colorants or liquid food supplements, in particular animal food supplements (especially vitamins (for example vitamin E) or choline chloride).

The silica according to the invention obtained by the process according to the invention can be employed as catalyst support.

It can also be used as additive, in particular for bulk materials or thin-layer materials. It can be employed as paper or paint additive or for the preparation of battery separators.

The silica according to the invention or obtained by the process according to the invention can be used for liquid filtration (for example for the filtration of beer) or for gas filtration, in particular in chromatography.

Thus, it has a particularly advantageous application in cigarette filters, in particular as active filter (for the air breathed in) and, due to its ability to absorb volatile organic molecules, for example as retention supplement with the activated carbon conventionally employed in these filters, indeed even as replacement for said activated carbon.

The following examples illustrate the invention without, however, limiting the scope thereof.

### EXAMPLES 1-10

In each of these examples, use is made, as starting material, of a precipitated silica, in the powder form, having the following characteristics:

| | | |
|---|---|---|
| median particle size | 5.0 | μm |
| BET specific surface | 390 | m²/g |
| oil (DOP) uptake | 390 | ml/100 g |

This silica is introduced in the powder form into the pan of a Rotolab Zanchetta granulator, so as to fill 40% of the volume of the pan.

The speed of the rotor of the granulator is set at a value of 500 revolutions/min.

Water or an aqueous solution of inorganic binder is added, at a constant flow rate, to the pan comprising the silica subjected to stirring, this being done according to the examples.

The granulation conditions are mentioned in table 1 below.

In each example, the silica granules obtained on conclusion of the granulation are dried at a temperature of 70° C. in a ventilated oven.

According to the examples, the granules are or are not subsequently subjected to calcination at 400° C. for 135 minutes and then optionally to sieving.

The characteristics of the silica granules obtained are listed in table 3, in which the characteristics of the coconut activated carbon are also shown.

TABLE 1

| | 1 and | 2 and | 3 and | 4 and | 5 and |
|---|---|---|---|---|---|
| Examples | 6 | 7 | 8 | 9 | 10 |
| Binder | water | S1 | S2 | S3 | S4 |
| Concentration of the | — | 1% | 0.1% | 1% | 0.1% |
| solution of inorganic | | | | | |
| binder | | | | | |
| Volume of binder | 225 | 215 | 215 | 215 | 215 |
| (liquid) added | | | | | |
| (ml/100 g of powder) | | | | | |
| Content of inorganic | — | 2.1% | 0.2% | 2.1% | 0.2% |
| binder in the granules | | | | | |
| obtained | | | | | |
| Addition time for the | 23 | 13 | 15 | 14 | 14 |
| binder (min) | | | | | |
| Granulation time (min) | 5 | 10 | 8 | 7 | 6 |

S1, S2: aqueous sodium silicate solutions (SiO₂/Na₂O ratio by weight of 3.4)
S3, S4: aqueous calcium chloride solutions

### EXAMPLES 11-12

In each of these examples, use is made, as starting material, of a precipitated silica, in the powder form, having the following characteristics:

| | | |
|---|---|---|
| median particle size | 3.7 | μm |
| BET specific surface | 665 | m²/g |
| oil (DOP) uptake | 300 | ml/100 g |

This silica is introduced in the powder form into the pan of a Rotolab Zanchetta granulator, so as to fill 40% of the volume of the pan.

The speed of the rotor of the granulator is set at a value of 500 revolutions/min.

Water is added at a constant flow rate to the pan comprising the silica subjected to stirring.

The granulation conditions are mentioned in table 2 below.

In each example, the silica granules obtained on conclusion of the granulation are dried at a temperature of 70° C. in a ventilated oven.

The characteristics of the silica granules obtained are listed in table 3.

TABLE 2

| Examples | 11 | 12 |
|---|---|---|
| Binder | water | water |
| Concentration of the solution | — | — |
| of inorganic binder | | |
| Volume of binder (liquid) | 155 | 155 |
| added (ml/100 g of powder) | | |
| Content of inorganic binder | — | — |
| in the granules obtained | | |
| Addition time for the binder | 15 | 18 |
| (min) | | |
| Granulation time (min) | 35 | 27 |

TABLE 3

| | | | Median | Cohe- | | Mean pore |
|---|---|---|---|---|---|---|
| Exam- | Calci- | BET | size | sive | Vd1 | diameter |
| ples | nation | (m²/g) | (μm) | index | (cm³/g) | (nm) |
| activated | — | 1004 | 519 | 0.06 | 0.52 (*) | 2.0 (*) |
| carbon | | | | | | |
| 1 | no | 410 | 458 | 0.19 | 1.36 | 14.8 |
| 2 | no | 368 | 402 | 0.09 | 1.23 | 14.7 |
| 3 | no | 393 | 400 | 0.08 | 1.27 | 14.3 |
| 4 | no | 409 | 440 | 0.09 | 1.31 | 13.8 |
| 5 | no | 452 | 423 | 0.10 | 1.23 | 15.0 |
| 6 | yes | 408 | 509 | 0.18 | 1.32 | 15.4 |
| 7 | yes | 287 | 349 | 0.13 | 1.38 | 15.3 |
| 8 | yes | 389 | 357 | 0.09 | 1.39 | 14.2 |
| 9 | yes | 382 | 437 | 0.09 | 1.25 | 14.4 |
| 10 | yes | 388 | 435 | 0.11 | 1.48 | 14.3 |
| 11 | no | 630 | 572 | 0.11 | 0.94 | 13.4 |
| 12 | no | 616 | 410 | 0.08 | 0.91 | 12.9 |

(*) for the activated carbon, measurement is carried out by nitrogen porosimetry (Brunauer-Emmett-Teller) method

1.-28. (canceled)

29. A silica, comprising:
a median particle size of at least 100 μm and less than or equal to 2,000 μm;
a pore volume (Vd1), composed of the pores with a diameter of from 3.6 to 1,000 nm, of at least 0.3 cm³/g and less than or equal to 3.0 cm³/g;
a mean pore diameter, for the pores of the diameter of from 3.6 to 1,000 nm, of greater than 11 nm and less than or equal to 100 nm; and
a cohesive index (CI) of less than 0.25.

30. The silica as defined by claim 29, wherein the median particle size is greater than 300 μm and less than 590 μm.

31. The silica as defined by claim 29, wherein the pore volume (Vd1), composed of the pores with a diameter of from 3.6 and 1,000 nm, is at least 0.5 cm³/g.

32. The silica as defined by claim 29, wherein the pore volume (Vd1) composed of the pores with a diameter of from 3.6 to 1,000 nm, is at least 0.9 cm³/g.

33. The silica as defined by claim 29, wherein the mean pore diameter, for the pores with a diameter of from 3.6 to 1,000 nm, is at least 12 nm.

34. The silica as defined by claim 29, wherein the cohesive index (CI) is a value less than 0.20.

35. The silica as defined by claim 29, further comprising a BET specific surface of at least 50 m²/g and less than or equal to 900 m²/g.

36. The silica as defined by claim 29, wherein the median particle size is greater than 300 μm and less than or equal to 600 μm, and further comprises a BET specific surface of greater than 300 m²/g and less than or equal to 900 m²/g.

37. The silica as defined by claim 29, wherein the silica is provided in the form of granules.

38. The silica as defined by claim 29, wherein the silica is precipitated silica.

39. The silica as defined by claim 29, further comprising at least one binder.

40. The silica as defined by claim 39, wherein the binder is an alkaline earth metal, a magnesium salt, a beryllium salt, an alkali metal, a magnesium silicate, a beryllium silicate, a magnesium aluminate, a beryllium aluminate, a magnesium carbonate, a beryllium carbonate, an alkaline earth metal hydroxide optionally treated with CO₂, or inorganic particles of nanometric size.

41. The silica as defined by claim 39, wherein the at least one binder is an alkaline earth metal salt, wherein the alkaline earth metal is calcium, an alkali metal silicate, or an alkaline earth metal carbonate.

42. The silica as defined by claim 29, wherein the silica comprises from 0.05% to 10.0% by weight inorganic binder.

43. The silica as defined by claim 29, wherein the silica surface is functionalized by grafting or adsorption of organic molecules.

44. A process for the preparation of a silica, the process comprising wet granulating silica, optionally in the presence of at least one soluble inorganic binder, followed by heat treatment and optionally sieving to obtain a silica comprising:
a median particle size of at least 100 μm and less than or equal to 2,000 μm;
a pore volume (Vd1), composed of the pores with a diameter of from 3.6 to 1,000 nm, of at least 0.3 cm³/g and less than or equal to 3.0 cm³/g;
a mean pore diameter, for the pores of the diameter of from 3.6 to 1,000 nm, of greater than 11 nm and less than or equal to 100 nm; and
a cohesive index (CI) of less than 0.25.

45. The process as defined by claim 44, wherein the granulation stage is carried out in a granulation device by processing a silica and a water-comprising binder, wherein the processed silica exhibits a median particle size of at least 0.5 μm and less than or equal to 50 μm.

46. The process as defined by claim 44, wherein the granulation stage employs a total liquid volume, comprising the binder, per 100 g of silica, representing 40% to 70% of the value of oil (DOP) uptake of the silica used.

47. The process as defined by claim 44, wherein processing of the binder comprises at least one of adding water, adding water and at least one soluble inorganic binder soluble optionally in aqueous solution, and adding an aqueous solution of a soluble inorganic binder.

48. The process as defined by claim 44, wherein the inorganic binder is an alkaline earth metal, a magnesium salt, a beryllium salt, an alkali metal, a magnesium silicate, a beryllium silicate, a magnesium aluminate, a beryllium aluminate, a magnesium carbonate, a beryllium carbonate, an alkaline earth metal hydroxide optionally treated with CO₂, or inorganic particles of nanometric size.

49. The process as defined by claim 44, wherein the inorganic binder is an alkaline earth metal salt, wherein the alkaline earth metal is calcium, an alkali metal silicate, or an alkaline earth metal carbonate.

50. The process as defined by claim 44, wherein the granulation stage is carried out in a rotary granulator equipped with blades or pins.

51. The process as defined by claim 44, wherein the heat treatment comprises a drying stage at a temperature of from 40° C. to 120° C.

52. The process as defined by claim 44, wherein the heat treatment comprises a calcination stage at a temperature of at least 200° C. and less than or equal to 500° C., the calcination stage being subsequent to a drying stage when the heat treatment comprises such a drying stage.

53. The process as defined by claim 44, wherein organic molecules are grafted to or adsorbed at the surface of the silica obtained on conclusion of the heat treatment or of the possible sieving.

54. A liquid carrier comprising a silica as defined in claim 29.

55. A solid support, additive or liquid or gas filtration means comprising a silica prepared by the process as defined by claim 44.

56. A cigarette filter comprising a silica prepared by the process as defined by claim 44.

57. A cigarette filter comprising a silica as defined by claim 29.
